(19) United States
(12) Patent Application Publication
(10) Pub. No.: US 2025/0166145 A1
(43) Pub. Date: May 22, 2025

(54) IMAGE PROCESSING APPARATUS, IMAGE CAPTURING APPARATUS, IMAGE PROCESSING METHOD, AND STORAGE MEDIUM

(71) Applicant: CANON KABUSHIKI KAISHA, Tokyo (JP)

(72) Inventor: YOHEI YAMANAKA, Kanagawa (JP)

(21) Appl. No.: 18/951,051

(22) Filed: Nov. 18, 2024

(30) Foreign Application Priority Data
Nov. 21, 2023 (JP) 2023-197592

(51) Int. Cl. G06T 5/92; G06T 5/50; G06T 5/70

(52) U.S. Cl. CPC G06T 5/92; G06T 5/50; G06T 5/70; G06T 2207/20208

(57) ABSTRACT

There is provided an apparatus. A first generation unit generates a first image with a first dynamic range from a shot image. A second generation unit generates a second image with a second dynamic range from the shot image. A gain map generation unit generates, based on the first image and the second image, a gain map for converting a dynamic range of the second image into the first dynamic range. A reduction unit applies first noise reduction processing to the gain map. An associates the gain map with the second image.

### BACKGROUND

### Technical Field

The aspect of the embodiments relates to an image processing apparatus, an image capturing apparatus, an image processing method, and a storage medium.

### Description of the Related Art

Along with an increase in the display luminance of displays, high dynamic range (HDR) camera systems have been proposed that obtain images capable of reproducing tones on the high-luminance side, which have been conventionally compressed, as tones that have more resemblance to the appearance. HDR can represent a wider dynamic range than standard dynamic range (SDR).

Also, a technique is known that generates a gain map for mutual conversion between an SDR image and an HDR image based on the SDR image and the HDR image, and stores the SDR image or the HDR image as a baseline image into a file together with the gain map. According to this technique, for example, in a case where the baseline image is the HDR image, the SDR image can be generated by applying the gain map to the baseline image. This makes it possible to select and display one of the SDR image and the HDR image that is appropriate for a display that displays images in accordance with whether the display supports HDR.

Furthermore, Japanese Patent Laid-Open No. 2018-128764 discloses a technique to perform tone conversion that emphasizes contrast in consideration of noise. According to Japanese Patent Laid-Open No. 2018-128764, noise suppression is performed with respect to an input image, and a gain map composed of gain values that correspond to respective pixels is generated from the input image after the noise suppression and a low-frequency image that has been generated. Then, using the gain map, gain processing is executed with respect to the input image after the noise suppression.

If a gain map for mutual conversion between an HDR image and an SDR image includes noise, there is a possibility of deterioration in the image quality of an image obtained by applying the gain map to a baseline image.

As Japanese Patent Laid-Open No. 2018-128764 does not mention processing aimed for a gain map for mutual conversion between an HDR image and an SDR image, it cannot address issues related to noise included in the gain map for mutual conversion between the HDR image and the SDR image.

### SUMMARY

According to a first aspect of the embodiments, there is provided a processing apparatus, comprising: a first generation unit configured to generate a first image with a first dynamic range from a shot image; a second generation unit configured to generate a second image with a second dynamic range from the shot image; a gain map generation unit configured to generate, based on the first image and the second image, a gain map for converting a dynamic range of the second image into the first dynamic range; a reduction unit configured to apply first noise reduction processing to the gain map; and an association unit configured to associate the gain map with the second image.

According to a second aspect of the embodiments, there is provided a processing apparatus, comprising: a first generation unit configured to generate a first image which has a first dynamic range, and to which first noise reduction processing has been applied, from a shot image; a second generation unit configured to generate a second image which has a second dynamic range, and to which the first noise reduction processing has been applied, from the shot image; a third generation unit configured to generate a third image which has the second dynamic range, and to which second noise reduction processing has been applied at an intensity independent of the first noise reduction processing, from the shot image; a gain map generation unit configured to generate, based on the first image and the second image, a gain map for converting a dynamic range of the third image into the first dynamic range; and an association unit configured to associate the gain map with the third image.

According to a third aspect of the embodiments, there is provided a capturing apparatus, comprising: the processing apparatus according to the first aspect; and a shooting unit configured to generate the shot image.

According to a fourth aspect of the embodiments, there is provided a processing method executed by a processing apparatus, comprising: generating a first image with a first dynamic range from a shot image; generating a second image with a second dynamic range from the shot image; generating, based on the first image and the second image, a gain map for converting a dynamic range of the second image into the first dynamic range; applying first noise reduction processing to the gain map; and associating the gain map with the second image.

According to a fifth aspect of the embodiments, there is provided a processing method executed by a processing apparatus, comprising: generating a first image which has a first dynamic range, and to which first noise reduction processing has been applied, from a shot image; generating a second image which has a second dynamic range, and to which the first noise reduction processing has been applied, from the shot image; generating a third image which has the second dynamic range, and to which second noise reduction processing has been applied at an intensity independent of the first noise reduction processing, from the shot image; generating, based on the first image and the second image, a gain map for converting a dynamic range of the third image into the first dynamic range; and associating the gain map with the third image.

According to a sixth aspect of the embodiments, there is provided a non-transitory computer-readable storage medium which stores a program for causing a computer to execute a processing method comprising: generating a first image with a first dynamic range from a shot image; generating a second image with a second dynamic range from the shot image; generating, based on the first image and the second image, a gain map for converting a dynamic range of the second image into the first dynamic range; applying first noise reduction processing to the gain map; and associating the gain map with the second image.

According to a seventh aspect of the embodiments, there is provided a non-transitory computer-readable storage medium which stores a program for causing a computer to execute a processing method comprising: generating a first image which has a first dynamic range, and to which first noise reduction processing has been applied, from a shot image; generating a second image which has a second dynamic range, and to which the first noise reduction processing has been applied, from the shot image; generating a third image which has the second dynamic range, and to which second noise reduction processing has been applied at an intensity independent of the first noise reduction processing, from the shot image; generating, based on the first image and the second image, a gain map for converting a dynamic range of the third image into the first dynamic range; and associating the gain map with the third image.

Further features of the disclosure will become apparent from the following description of exemplary embodiments with reference to the attached drawings.

### BRIEF DESCRIPTION OF THE DRAWINGS

FIG. 1 is a block diagram showing an exemplary configuration of an image capturing apparatus 100 to which an image processing apparatus has been applied.

FIG. 2 is a block diagram showing an exemplary configuration of an image processing unit 104 according to a first embodiment.

FIG. 3 is a block diagram showing an exemplary configuration of an SDR development processing unit 201, an HDR development processing unit 202, and a baseline HDR development processing unit 801.

FIG. 4 is a flowchart showing exemplary operations of the image processing unit 104 according to the first embodiment.

FIGS. 5A and 5B are diagrams showing examples of the EOTFs used in a linear gamma conversion unit 203.

FIG. 6 is a diagram showing an example of a relationship between the reduction rate of a gain map and the amount of application of noise reduction.

FIG. 7 is a diagram showing an example of table data that defines a filter coefficient and a filter matrix corresponding to each setting value of an NR setting.

FIG. 8 is a block diagram showing an exemplary configuration of an image processing unit 104 according to a second embodiment.

FIG. 9 is a flowchart showing exemplary operations of the image processing unit 104 according to the second embodiment.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

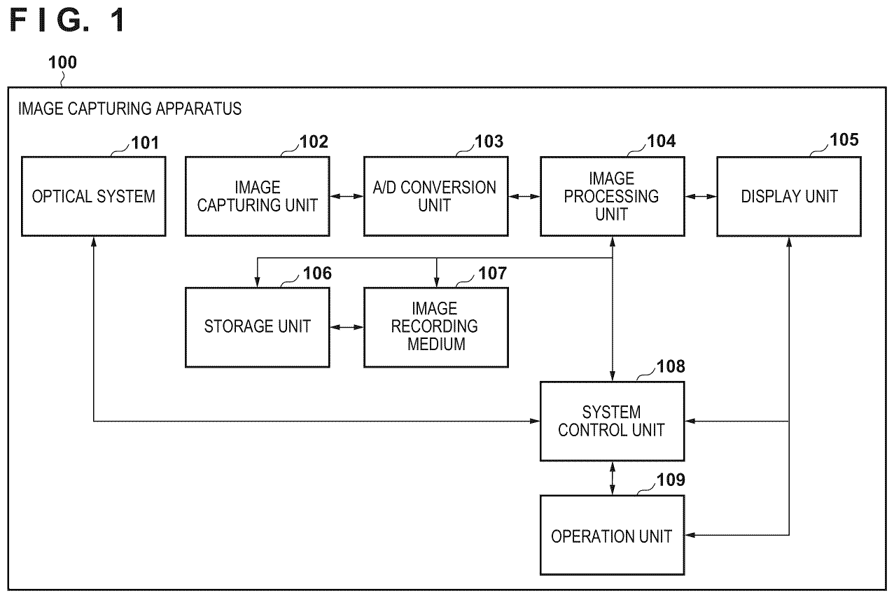

FIG. 1 is a block diagram showing an exemplary configuration of an image capturing apparatus 100 to which an image processing apparatus according to a first embodiment has been applied. The image capturing apparatus 100 includes an optical system 101, an image capturing unit 102, an A/D conversion unit 103, an image processing unit 104, a display unit 105, a storage unit 106, an image recording medium 107, a system control unit 108, and an operation unit 109.

The image capturing apparatus 100 executes processing for generating an SDR image and an HDR image using the image processing unit 104 based on an image generated through shooting that uses the image capturing unit 102 (a shot image), and generating a gain map that enables reconstruction of HDR representation and SDR representation.

Note that in the present embodiment, an HDR image is an image that has a wider dynamic range than an SDR image, and is, for example, an image incorporating the opto-electronic transfer function (OETF) described in, for example, ST 2084, which is the HDR standard handled on an HDR monitor. Furthermore, an SDR image is an image that has a narrower dynamic range than an HDR image. The present embodiment will be described under the assumption that the gamma and gamut of an HDR image are the OETF characteristics of ST 2084 and Rec. 2020, respectively, whereas the gamma and gamut of an SDR image are sRGB gamma and sRGB, respectively.

In FIG. 1, the optical system 101 includes a lens assembly including a zoom lens and a focus lens, a diaphragm adjustment apparatus, and a shutter apparatus. The optical system 101 adjusts the magnification, focus position, and light amount of a subject image that arrives at the image capturing unit 102. The image capturing unit 102 includes an image sensor, such as a CCD sensor and a CMOS sensor, that converts a light beam of the subject image that has passed through the optical system 101 into electrical signals (image signals) through photoelectric conversion. The A/D conversion unit 103 generates a digital image by applying analog-digital conversion to image signals input from the image capturing unit 102.

The image processing unit 104 executes development processing, such as pixel interpolation processing, linear gamma conversion for generating a gain map, processing for converting a color space, and the like with respect to an image output from the A/D conversion unit 103 (a shot image). Also, the image processing unit 104 executes, for example, predetermined compression processing for recording an image into the image recording medium 107, which will be described later. The image processing unit 104 can execute similar image processing with respect to not only images output from the A/D conversion unit 103, but also images that have been read out from the image recording medium 107.

The display unit 105 displays a viewfinder image at the time of shooting, displays a shot image, displays characters for interactive operations, and so forth. The display unit 105 displays images generated by the image processing unit 104, and images that have been read out from the image recording medium 107. The display unit 105 is, for example, a liquid crystal display or an organic electro luminescence (EL) display.

The storage unit 106 stores, for example, an image processing program and various types of information that are necessary for image processing executed by the image processing unit 104.

The image recording medium 107 includes a function of recording images. For example, the image recording medium may include a memory card equipped with a semiconductor memory, or may include a recording medium that uses, for example, a package etc. in which a rotative recording member, such as a magnetic disk, is housed. The image recording medium 107 may be configured to be attachable to and removable from the image capturing apparatus 100.

The system control unit 108 controls the entirety of the image capturing apparatus 100. The system control unit 108 includes, for example, a CPU (or MPU), a ROM, a RAM, and the like, and performs various types of control, including control on the entirety of the image capturing apparatus 100, by deploying a program stored in the ROM to a working area of the RAM and executing the program.

The operation unit 109 is intended to accept a user operation. For example, a button, a lever, a touch panel, or the like can be used as the operation unit 109. A user can configure settings of a shooting mode that suit the user's preference via the operation unit 109. Settings of a shooting mode include a setting of the intensity of noise reduction. In the present specification, “noise reduction” may be referred to as “NR”. Also, the setting of the NR intensity may be referred to as an “NR setting”. Setting values of the NR intensity setting include such setting values as “OFF (noise reduction is not performed)”, “low”, “normal”, and “high”. For example, in a case where the user wants an image with a focus on sharpness at the expense of the noise amount in shooting of a landscape photograph, the user can obtain more effective image characteristics by changing the NR intensity setting to OFF.

Note that although the optical system 101 is configured as a part of the image capturing apparatus 100 that includes the image capturing unit 102 in the example of FIG. 1, the present embodiment is not limited to this configuration. For example, it is permissible to use an image capturing system configured to allow an interchangeable optical system (an interchangeable lens) to be attached to and removed from the body of the image capturing apparatus 100, such as a single-lens reflex camera.

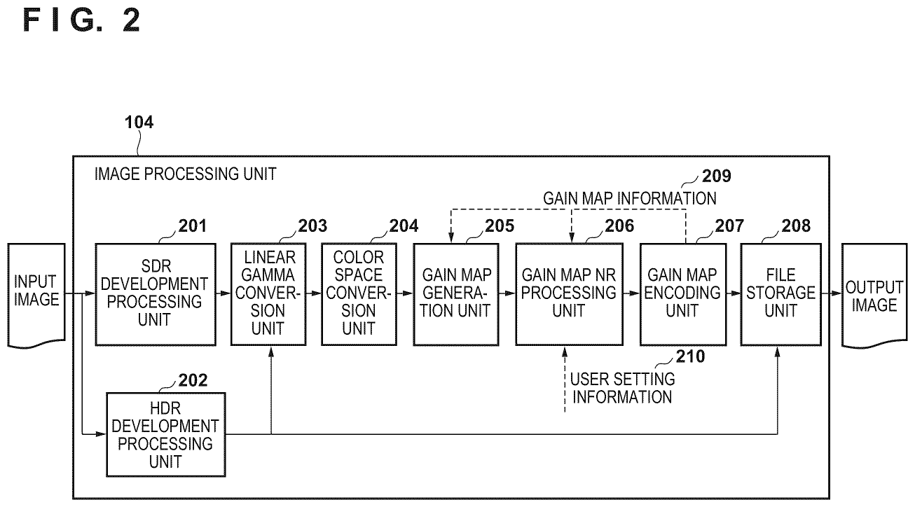

FIG. 2 is a block diagram showing an exemplary configuration of the image processing unit 104 according to the first embodiment. The image processing unit 104 includes an SDR development processing unit 201, an HDR development processing unit 202, a linear gamma conversion unit 203, a color space conversion unit 204, a gain map generation unit 205, a gain map NR processing unit 206, a gain map encoding unit 207, and a file storage unit 208.

It is assumed here that an input image input to the image processing unit 104 (a shot image) is a digital image generated by causing the A/D conversion unit 103 to apply A/D conversion to signals obtained by the image capturing unit 102. It is also assumed that this digital image is a Bayer image composed of three components, namely red (R), green (G), and blue (B).

The SDR development processing unit 201 executes processing for generating an SDR image by applying SDR development processing to an input image (image generation processing). The HDR development processing unit 202 executes processing for generating an HDR image by applying HDR development processing to an input image (image generation processing). The development processing refers to processing for generating a YUV image or an RGB image appropriate for an output apparatus (not shown), such as a display, from the input Bayer image.

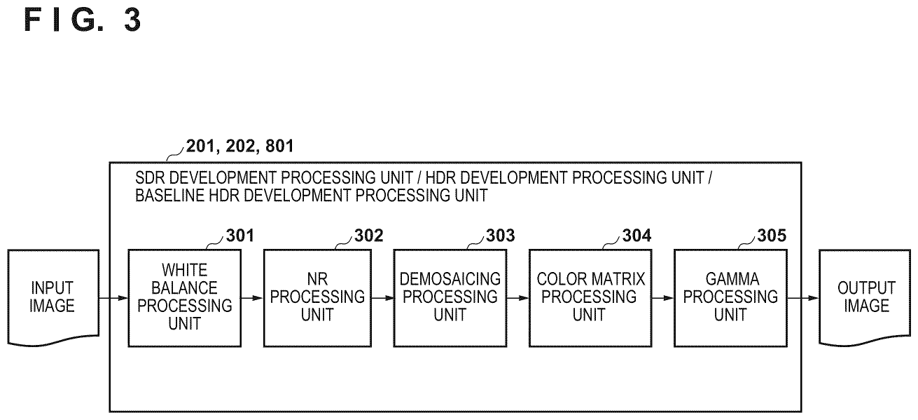

With reference to FIG. 3, a description is now given of exemplary configurations of the SDR development processing unit 201 and the HDR development processing unit 202. As shown in FIG. 3, the exemplary configurations of the SDR development processing unit 201 and the HDR development processing unit 202 can be represented by the same block diagram. Note that although FIG. 3 also depicts an exemplary configuration of a baseline HDR development processing unit 801, a description thereof will be provided in a second embodiment.

Each of the SDR development processing unit 201 and the HDR development processing unit 202 includes a white balance processing unit 301, an NR processing unit 302, a demosaicing processing unit 303, a color matrix processing unit 304, and a gamma processing unit 305. The SDR development processing unit 201 and the HDR development processing unit 202 obtain a Bayer image as an input image, and generates a YUV image or an RGB image appropriate for an output apparatus (not shown), such as a display, as an output image.

The white balance processing unit 301 executes white balance processing for adjusting a color balance with respect to an input image.

The NR processing unit 302 executes NR processing for reducing dark current noise and photon shot noise with respect to an input image. It is sufficient to apply a general method that uses a low-pass filter (LPF), a bilateral filter, or the like as the NR processing. Furthermore, the intensity of the NR processing (the intensity of noise reduction in the NR processing) is controlled in accordance with the NR setting that is configured by the user via the operation unit 109. Therefore, the operation unit 109 has a function as an acceptance unit that accepts the setting of the intensity of the NR processing (NR setting) from the user. For example, in a case where the NR setting has been set to OFF, the NR processing unit 302 passes an input image to the demosaicing processing unit 303 without applying the NR processing. Also, in a case where the NR setting has been set to low, normal, or high, the NR processing unit 302 can execute the NR processing at the set intensity by using a filter coefficient and a filter matrix corresponding to the NR setting.

With respect to an input image, the demosaicing processing unit 303 executes demosaicing processing for generating a three-plane image of R, G, and B from a Bayer image. For example, a general method, such as linear interpolation and adaptive interpolation, can be applied as the demosaicing processing.

The color matrix processing unit 304 executes color matrix processing for causing an input image to shift from the spectral characteristics of the image sensor and conform with the gamut of the output apparatus.

With respect to an input image, the gamma processing unit 305 executes gamma processing for converting signal values in accordance with the gamma characteristics (OETF) for generating signals that conform with the monitor gamma (OETF) of the output apparatus.

Note that, as stated earlier, the SDR development processing unit 201 and the HDR development processing unit 202 can be represented as the same block diagram. However, different parameters are used as appropriate as parameters for various types of processing in accordance with the type of the output image (SDR image or HDR image). For example, while the gamma processing unit 305 of the SDR development processing unit 201 uses sRGB gamma as the gamma characteristics to be applied to the input image, the gamma processing unit 305 of the HDR development processing unit 202 uses the OETF characteristics of ST 2084 as the gamma characteristics to be applied to the input image.

Referring back to FIG. 2, the linear gamma conversion unit 203 converts the gamma characteristics of the SDR image and the HDR image generated by the SDR development processing unit 201 and the HDR development processing unit 202 into linear gamma. For example, in the case of the SDR image, a method of converting nonlinear SDR signals into linear signals using the electro-optical transfer function (EOTF) of SDR can be used as a linearization method. Specifically, the reference EOTF defined by ITU-R BT. 709 can be used.

The color space conversion unit 204 converts the SDR image and the HDR image that have been linearized by the linear gamma conversion unit 203 into the same color space. For example, to bring the color space in conformity with Rec. 2020, the color space conversion unit 204 executes a color space conversion from sRGB to Rec. 2020 with respect to the SDR image. For example, a method described in ITU-R BT. 2087 can be used as a method of color space conversion.

The gain map generation unit 205 generates a gain map based on the SDR image and the HDR image to which the color space conversion unit 204 has applied color space conversion. In processing for generating the gain map in the gain map generation unit 205, gain values are calculated by obtaining logarithms of ratios between SDR and HDR for the respective pixels as indicated by the following formula (1). In formula (1), SDR and k_{SDR} are respectively a pixel value and an offset value of the SDR image, HDR and k_{HDR} are respectively a pixel value and an offset value of the HDR image, and G is a gain value.

$$G = {Log}_{2} ( \frac{HDR + {k}_{HDR}}{SDR + {k}_{SDR}} ) \qquad ( 1 )$$

Here, the gain map generation unit 205 may generate gain values with respect to grayscale of one channel, or may generate gain values with respect to each of the RGB planes of three channels. In the case of grayscale of one channel, the gain map generation unit 205 performs conversion from RGB to YUV, and calculates gain values from Y values of YUV. Furthermore, the gain map generation unit 205 stores information (e.g., the number of channels for gain values and the like) necessary for the execution of encoding in the gain map encoding unit 207, which will be described later, into the storage unit 106 as metadata.

Applying the gain map to one of the SDR image and the HDR image enables generation of the other image. Therefore, when one of the SDR image and the HDR image and the gain map are stored in an image file, both of the SDR image and the HDR image can be obtained from the image file. An image that is stored in an image file together with the gain map will be referred to as a baseline image or a main image.

According to formula (1), gain values based on the pixel values of the SDR image are calculated. Therefore, in a case where a gain map calculated in accordance with formula (1) is stored in an image file, if the baseline image is the SDR image, the HDR image can be generated by multiplying the pixel values of the SDR image by the gain values of the gain map. On the other hand, in a case where a gain map calculated in accordance with formula (1) is stored in an image file, if the baseline image is the HDR image, the SDR image can be generated by multiplying the pixel values of the HDR image by the reciprocals of the gain values of the gain map.

The gain map NR processing unit 206 executes NR processing for reducing random noise included in an input image and noise generated by a resolution reduction to the gain map generated by the gain map generation unit 205. The two methods described below are typical methods of NR processing for the gain map. The gain map NR processing unit 206 may use one of the methods, or may use the two methods in combination. Furthermore, the methods of NR processing for the gain map also include various other methods that will be described later. The gain map NR processing unit 206 can use one of the aforementioned two methods and various other methods, or a combination of two or more arbitrary methods among these plurality of methods.

The first method of NR processing is a method based on a reduction rate of the gain map. According to this method, the gain map NR processing unit 206 controls the amount of application of noise reduction based on gain map information 209 including the reduction rate of the resolution reduction of the gain map performed by the gain map encoding unit 207, which will be described later. The reduction rate of the gain map denotes a post-reduction size provided that the original size (resolution) is 1. As the original size of the gain map matches the size of the SDR image and the HDR image, the reduction rate of the gain map is equivalent to the ratio of the size (resolution) of the gain map to that of the baseline image.

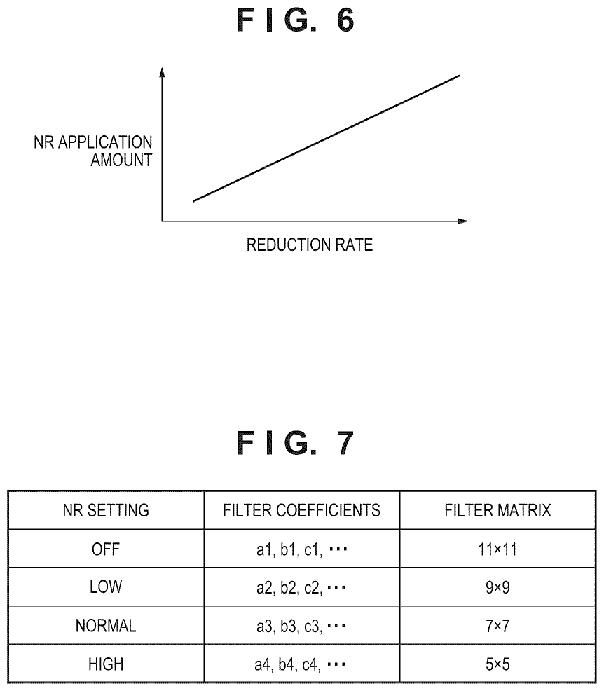

For example, the gain map NR processing unit 206 controls the amount of application of noise reduction by generating a gain map to which a noise-reducing LPF has been applied, and changing the composite ratio of the gain map before and after the application of the LPF in accordance with the resolution reduction rate. For example, as shown in FIG. 6, the gain map NR processing unit 206 controls the amount of application of noise reduction so as to lower (reduce) the intensity of noise reduction for a smaller reduction rate, and enhance (increase) the intensity of noise reduction for a larger reduction rate. Reducing the resolution of the gain map has the advantageous effect of noise reduction, and noise decreases as the reduction rate decreases; therefore, by performing control in the foregoing manner, noise remaining in the reduced gain map can be reduced appropriately. Also, as the gain map NR processing unit 206 suppresses aliasing (folding noise) generated by the reduction in the resolution of the gain map in the gain map encoding unit 207, an LPF for removing frequency components that exceed the Nyquist frequency may be applied.

The second method of NR processing is a method based on the NR setting of the shooting mode. According to this method, the gain map NR processing unit 206 controls the intensity of noise reduction based on user setting information 210 including information of the NR setting of the shooting mode configured by the user via the operation unit 109.

For example, in a case where the NR setting is OFF, the NR processing unit 302 does not execute the NR processing with respect to the SDR image and the HDR image. Therefore, in a case where the NR setting is OFF, it is considered that the gain map includes a large amount of noise compared to the case of another setting value (e.g., normal). In view of this, the gain map NR processing unit 206 executes the NR processing with respect to the gain map using a filter coefficient and a filter matrix that enhance the intensity of noise reduction. Conversely, in a case where the NR setting is high, it is considered that the gain map includes a small amount of noise compared to the case of another setting value (e.g., normal). In view of this, the gain map NR processing unit 206 executes the NR processing with respect to the gain map using a filter coefficient and a filter matrix that lower the intensity of noise reduction. In this way, the gain map NR processing unit 206 performs control so that the lower the intensity of the NR setting (the intensity of the NR processing applied to the SDR image and the HDR image), the higher the intensity of NR processing for the gain map. FIG. 7 is a diagram showing an example of table data that defines a filter coefficient and a filter matrix corresponding to each setting value of the NR setting. The table data of FIG. 7 is stored in the storage unit 106 in advance.

Furthermore, various other methods of NR processing include a method based on the bit depth of the gain map included in the gain map information 209, a method based on the minimum value and the maximum value of luminance values of the baseline image, a method based on the shooting sensitivity (International Organization for Standardization (ISO) sensitivity) of a shot image, a method based on the shape of gamma applied to the baseline image, and a method based on the variance in a flat area of an image.

According to the method based on the bit depth, the gain map NR processing unit 206 performs control so that the smaller the bit depth of the gain map (the smaller the number of bits of each gain value in the gain map), the lower the intensity of noise reduction. A smaller bit depth makes a distinction between signals and noise more difficult to make; therefore, by performing control in the foregoing manner, noise in the gain map can be reduced at an appropriate intensity.

According to the method based on the minimum value and the maximum value of luminance values of the baseline image, the gain map NR processing unit 206 performs conversion from RGB to YUV, and obtains the maximum value and the minimum value of Y values of YUV (luminance values). It is considered that the difference between the maximum value and the minimum value of luminance values serves as an index for a noise amount that is amplified when the gain map is applied to the baseline image. In view of this, the gain map NR processing unit 206 performs control so that the larger the difference between the maximum value and the minimum value of luminance values, the higher the intensity of noise reduction.

According to the method based on the shooting sensitivity (ISO sensitivity) of a shot image, the gain map NR processing unit 206 performs control so that the higher the shooting sensitivity, the higher the intensity of noise reduction. In a case where the shooting sensitivity is high, the noise amount in the SDR image and the HDR image used in generation of the gain map increases, and it is thus considered that the noise amount in the gain map increases as well. For this reason, by performing control in the foregoing manner, noise in the gain map can be reduced at an appropriate intensity.

Regarding the method based on the shape of gamma applied to the baseline image, there is a value range in which contrast increases depending on the shape of gamma, and low-amplitude noise that was not easily viewed before the application of gamma may be enhanced after the application of gamma. In view of this, the gain map NR processing unit 206 performs control to enhance the intensity of noise reduction in a case where the inclination of the input-output characteristics associated with this value range is steep, and performs control to conversely lower the intensity of noise reduction in a case where the inclination of the input-output characteristics is gentle.

According to the method based on the variance in a flat area of an image, the gain map NR processing unit 206 calculates the variance of pixel values in a flat area of at least one of the SDR image and the HDR image used in generation of the gain map. It is considered that the magnitude of the calculated variance serves as an index of a noise amount in the gain map. In view of this, the gain map NR processing unit 206 performs control so that the larger the variance, the higher the intensity of noise reduction.

The gain map encoding unit 207 encodes the gain map to which the NR processing has been applied in the gain map NR processing unit 206 in a format conforming with the specification of an output image file. Although quantization is performed in encoding, it is not necessary for the bit depth of the gain map to match the bit depth of the baseline image, and it is sufficient that the bit depth of the gain map match or exceed the bit depth of the HDR image. For example, in a case where the baseline image is an 8-bit SDR image and an HDR image obtained by combining the SDR image and the gain map has 10 bits, in one embodiment, the bit depth of the gain map is to be equal to or larger than 10 bits.

Furthermore, in encoding, processing for downsampling the gain map to a low resolution is executed in order to reduce the file size. For example, the gain map encoding unit 207 reduces the resolution of the gain map corresponding to the resolution of an input image by, for example, ¼ (½ in the horizontal direction, and ½ in the vertical direction). In addition, the gain map encoding unit 207 calculates the minimum value and the maximum value of each RGB plane of the gain map.

The file storage unit 208 stores the gain map encoded by the gain map encoding unit 207, as well as the metadata and the baseline image stored into the storage unit 106 by the gain map generation unit 205, into an image file. Storing the gain map and the baseline image into the image file makes the baseline image associated with the gain map.

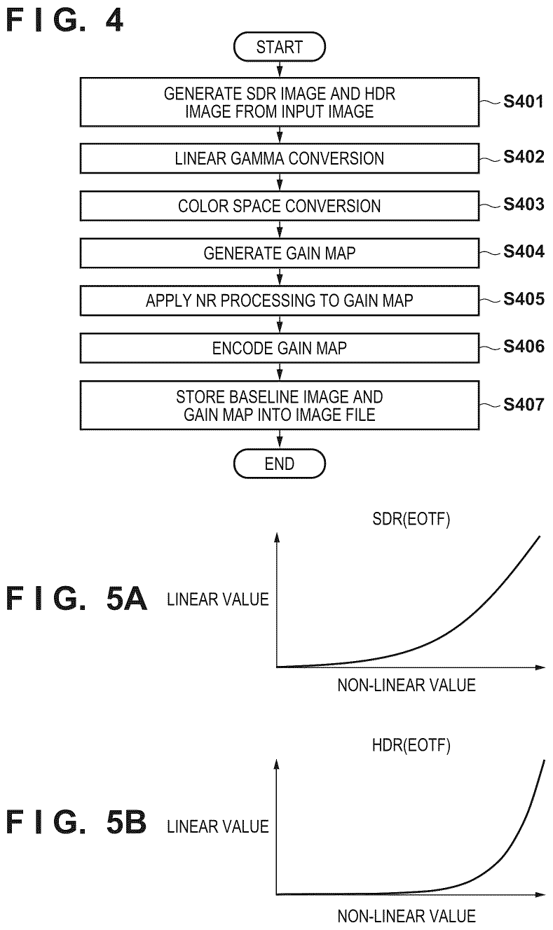

FIG. 4 is a flowchart showing exemplary operations of the image processing unit 104 according to the first embodiment. Each type of processing shown in the present flowchart may be realized by, for example, the CPU or the like executing the image processing program according to the present embodiment. Alternatively, a part or an entirety of processing shown in the present flowchart may be realized by hardware, such as an electronic circuit. Although the following describes a case where the baseline image is an HDR image, the baseline image of the present embodiment is not limited to the HDR image, and may be an SDR image.

In step S401, the SDR development processing unit 201 and the HDR development processing unit 202 of the image processing unit 104 generate an SDR image and an HDR image from an input image (Bayer image) from the A/D conversion unit 103.

In step S402, the linear gamma conversion unit 203 executes processing of conversion into linear gamma with respect to the SDR image and the HDR image generated in step S401. A method of converting nonlinear signals into linear signals using the EOTF functions shown in FIG. 5A and FIG. 5B can be used as a linearization method. Note that FIG. 5A shows an example of the EOTF function for the SDR image, and FIG. 5B shows an example of the EOTF function for the HDR image.

In step S403, the color space conversion unit 204 converts the SDR image and the HDR image, which have been converted into linear gamma in step S402, into the same color space. It is assumed here that a color space conversion from sRGB to Rec. 2020 is executed with respect to the SDR image.

In step S404, the gain map generation unit 205 generates a gain map based on the SDR image and the HDR image to which the color space conversion has been applied in step S403. The details of the generation method are as described above with reference to formula (1). It is assumed here that the gain map generation unit 205 generates a gain map for each of the RGB planes of three channels. In one embodiments, the gain map generation unit 205 stores information (e.g., information related to the number of channels, the gain map information 209, and the like) necessary for the execution of encoding in the gain map encoding unit 207 into the storage unit 106 as metadata.

In step S405, the gain map NR processing unit 206 executes NR processing for reducing random noise included in an input image and noise generated by a resolution reduction to the gain map generated in step S404. As stated earlier, the methods of NR processing for the gain map include the method based on the reduction rate of the gain map, the method based on the NR setting of the shooting mode, and various other methods. The gain map NR processing unit 206 can use one of these methods, or a combination of two or more arbitrary methods among these methods.

In step S406, the gain map encoding unit 207 encodes the gain map to which the NR processing has been applied in step S405 in a format conforming with the specification of an output image file. Here, the resolution of an input image is reduced by ¼ (½ in the horizontal direction, and ½ in the vertical direction). Furthermore, the gain map encoding unit 207 calculates the minimum value and the maximum value of each plane (R, G, or B) of the gain map.

In step S407, the file storage unit 208 stores the HDR image generated in step S401 and the gain map encoded in step S406 into the output image file. Furthermore, the file storage unit 208 also stores the metadata stored into the storage unit 106 in step S404 into the output image file. Here, the HDR image is stored into the file as the baseline image (main image); however, in a case where the baseline image is the SDR image, the file storage unit 208 stores the SDR image generated in step S401 into the output image file instead of the HDR image.

As described above, according to the first embodiment, the image capturing apparatus 100 generates a first image with a first dynamic range and a second image with a second dynamic range from a shot image. For example, in a case where an HDR image is used as a baseline image, the first image is an SDR image, and the second image is the HDR image. Also, in a case where an SDR image is used as a baseline image, the first image is an HDR image, and the second image is the SDR image. Based on the first image and the second image, the image capturing apparatus 100 generates a gain map for converting a dynamic range of the second image (baseline image) into the first dynamic range. The image capturing apparatus 100 applies NR processing (first noise reduction processing) to the gain map, and associates the gain map with the second image (baseline image).

In this way, the present embodiment suppresses noise in the gain map generated based on two images with different dynamic ranges (e.g., the SDR image and the HDR image). Therefore, the present embodiment makes it possible to improve the image quality of an image generated by applying the gain map to the baseline image.

### Second Embodiment

Next, a second embodiment will be described. The basic configuration of the image capturing apparatus 100 according to the second embodiment is similar to that of the first embodiment. The following mainly describes the differences from the first embodiment.

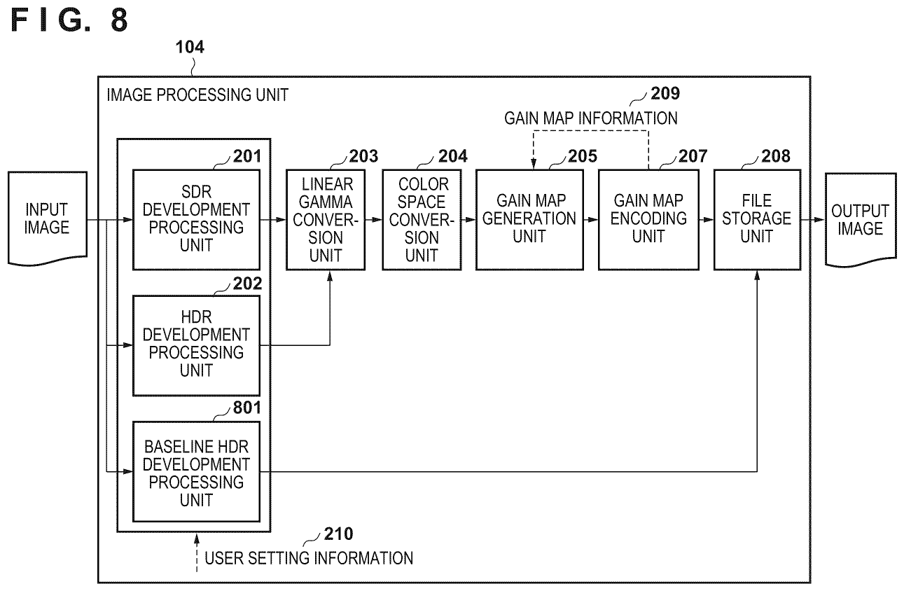

FIG. 8 is a block diagram showing an exemplary configuration of an image processing unit 104 according to the second embodiment. The image processing unit 104 includes an SDR development processing unit 201, an HDR development processing unit 202, a linear gamma conversion unit 203, a color space conversion unit 204, a gain map generation unit 205, a gain map encoding unit 207, a file storage unit 208, and a baseline HDR development processing unit 801.

The baseline HDR development processing unit 801 generates an HDR image as a baseline image by executing HDR development processing with respect to an input image.

With reference to FIG. 3, a description is now given of exemplary configurations of the SDR development processing unit 201, the HDR development processing unit 202, and the baseline HDR development processing unit 801.

The exemplary configurations of the SDR development processing unit 201 and the HDR development processing unit 202 can be represented by the block diagram of FIG. 3, similarly to the first embodiment. However, the method of controlling the intensity of noise reduction in the NR processing units 302 of the SDR development processing unit 201 and the HDR development processing unit 202 differs from that of the first embodiment. In the first embodiment, the NR processing is executed at an intensity corresponding to the NR setting of the shooting mode. On the other hand, in the second embodiment, the NR processing units 302 of the SDR development processing unit 201 and the HDR development processing unit 202 execute the NR processing at an intensity appropriate for reducing noise in a gain map to be generated later, irrespective of the NR setting. For example, the NR processing units 302 of the SDR development processing unit 201 and the HDR development processing unit 202 may control the intensity of noise reduction based on at least one of the shooting sensitivity (ISO sensitivity) of a shot image and the variance of pixel values in a flat area of the shot image. As can be understood from FIG. 8, in the second embodiment, an SDR image and an HDR image input to the gain map generation unit 205 have undergone the NR processing in the NR processing units 302 of the SDR development processing unit 201 and the HDR development processing unit 202 at an intensity appropriate for reducing noise in the gain map. Therefore, unlike the first embodiment, there is no need to execute the NR processing with respect to the gain map after the gain map is generated, and the image processing unit 104 of FIG. 8 need not include a gain map NR processing unit 206.

The exemplary configuration of the baseline HDR development processing unit 801 can be represented by the block diagram of FIG. 3, similarly to the SDR development processing unit 201 and the HDR development processing unit 202. However, the method of controlling the intensity of noise reduction in the NR processing unit 302 of the baseline HDR development processing unit 801 differs from that in the SDR development processing unit 201 and the HDR development processing unit 202 according to the second embodiment. The NR processing unit 302 of the baseline HDR development processing unit 801 executes the NR processing at an intensity corresponding to the NR setting accepted from a user, similarly to the SDR development processing unit 201 and the HDR development processing unit 202 according to the first embodiment. The operation unit 109 has a function as an acceptance unit that accepts the setting of the intensity of the NR processing (NR setting) from the user.

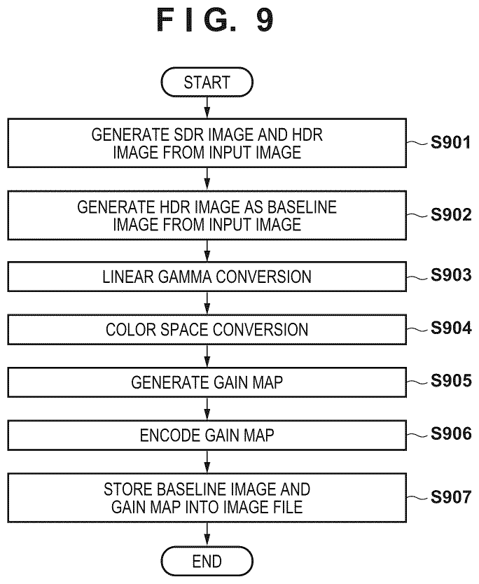

FIG. 9 is a flowchart showing exemplary operations of the image processing unit 104 according to the second embodiment. Each type of processing shown in the present flowchart may be realized by, for example, the CPU or the like executing the image processing program according to the present embodiment. Alternatively, a part or an entirety of processing shown in the present flowchart may be realized by hardware, such as an electronic circuit.

In step S901, the SDR development processing unit 201 and the HDR development processing unit 202 of the image processing unit 104 generate an SDR image and an HDR image to be used in generation of a gain map from an input image (Bayer image) from the A/D conversion unit 103.

In step S902, the baseline HDR development processing unit 801 of the image processing unit 104 generates an HDR image to be used as a baseline image from an input image (Bayer image) from the A/D conversion unit 103.

Processing of steps S903 to S905 are similar to processing of steps S402 to S404 of FIG. 4.

In step S906, the gain map encoding unit 207 encodes the gain map generated in step S905 in a format conforming with the specification of an output image file. Here, the resolution of an input image is reduced by ¼ (½ in the horizontal direction, and ½ in the vertical direction). Furthermore, the gain map encoding unit 207 calculates the minimum value and the maximum value of each plane (R, G, or B) of the gain map.

In step S907, the file storage unit 208 stores the HDR image as the baseline image generated in step S902 and the gain map encoded in step S906 into the output image file. Furthermore, the file storage unit 208 also stores the metadata stored into the storage unit 106 in step S905 into the output image file.

Note that although the above description has been provided under the assumption that the baseline image is an HDR image, the baseline image may be an SDR image. In this case, the baseline HDR development processing unit 801 is configured to generate an SDR image as the baseline image. Furthermore, the file storage unit 208 stores the SDR image generated as the baseline image in step S902 into the output image file.

As described above, according to the second embodiment, the image capturing apparatus 100 generates a first image which has a first dynamic range and to which noise reduction processing (first noise reduction processing) has been applied from a shot image. Also, the image capturing apparatus 100 generates a second image which has a second dynamic range and to which noise reduction processing (first noise reduction processing) has been applied from the shot image. Furthermore, the image capturing apparatus 100 generates a third image which has a second dynamic range and to which second noise reduction processing has been applied at an intensity independent of the first noise reduction processing from the shot image. The third image is an image used as a baseline image. In a case where the baseline image is an HDR image, the first image is an SDR image, and the second image is an HDR image as a non-baseline image. In a case where the baseline image is an SDR image, the first image is an HDR image, and the second image is an SDR image as a non-baseline image. Based on the first image and the second image, the image capturing apparatus 100 generates a gain map for converting a dynamic range of the third image (baseline image) into the first dynamic range. Then, the image capturing apparatus 100 associates the gain map with the third image (baseline image).

In this way, according to the present embodiment, a gain map is generated based on the first image and the second image to which the noise reduction processing has been applied at an intensity independent of the noise reduction processing for the baseline image. Therefore, the present embodiment makes it possible to suppress noise in the gain map irrespective of the intensity of the noise reduction processing for the baseline image, and improve the image quality of an image generated by applying the gain map to the baseline image.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-197592, filed Nov. 21, 2023, which is hereby incorporated by reference herein in its entirety.

What is claimed is:

1. A processing apparatus, comprising:
a first generation unit configured to generate a first image with a first dynamic range from a shot image;
a second generation unit configured to generate a second image with a second dynamic range from the shot image;
a gain map generation unit configured to generate, based on the first image and the second image, a gain map for converting a dynamic range of the second image into the first dynamic range;
a reduction unit configured to apply first noise reduction processing to the gain map; and
an association unit configured to associate the gain map with the second image.

2. The apparatus according to claim 1, wherein
a resolution of the gain map is lower than a resolution of the second image, and
the reduction unit controls an intensity of the first noise reduction processing based on a ratio of the resolution of the gain map to the resolution of the second image.

3. The apparatus according to claim 2, wherein
the reduction unit performs control so that the higher the ratio, the higher the intensity of the first noise reduction processing.

4. The apparatus according to claim 1, wherein
the first generation unit generates the first image to which second noise reduction processing has been applied,
the second generation unit generates the second image to which the second noise reduction processing has been applied, and
the reduction unit controls an intensity of the first noise reduction processing based on an intensity of the second noise reduction processing.

5. The apparatus according to claim 4, wherein
the reduction unit performs control so that the lower the intensity of the second noise reduction processing, the higher the intensity of the first reduction processing.

6. The apparatus according to claim 4, further comprising
an acceptance unit configured to accept a setting of the intensity of the second noise reduction processing from a user.

7. The apparatus according to claim 1, wherein
the reduction unit controls an intensity of the first noise reduction processing based on at least one of a bit depth of the gain map, a difference between a maximum value and a minimum value of luminance values of the second image, a shooting sensitivity of the shot image, a shape of gamma applied to the second image, and a variance of pixel values in a flat area of the first image or the second image.

8. An apparatus, comprising:
a first generation unit configured to generate a first image which has a first dynamic range, and to which first noise reduction processing has been applied, from a shot image;
a second generation unit configured to generate a second image which has a second dynamic range, and to which the first noise reduction processing has been applied, from the shot image;
a third generation unit configured to generate a third image which has the second dynamic range, and to which second noise reduction processing has been applied at an intensity independent of the first noise reduction processing, from the shot image;
a gain map generation unit configured to generate, based on the first image and the second image, a gain map for converting a dynamic range of the third image into the first dynamic range; and
an association unit configured to associate the gain map with the third image.

9. The apparatus according to claim 8, further comprising
a first control unit configured to control an intensity of the first noise reduction processing based on at least one of an International Organization for Standardization (ISO) sensitivity of the shot image and a variance of pixel values in a flat area of the shot image.

10. The apparatus according to claim 8, further comprising
an acceptance unit configured to accept a setting of an intensity of the second noise reduction processing from a user.

11. A capturing apparatus, comprising:
the apparatus according to claim 1; and
a shooting unit configured to generate the shot image.

12. A method executed by an apparatus, comprising:
generating a first image with a first dynamic range from a shot image;
generating a second image with a second dynamic range from the shot image;
generating, based on the first image and the second image, a gain map for converting a dynamic range of the second image into the first dynamic range;
applying first noise reduction processing to the gain map; and
associating the gain map with the second image.

13. A method executed by an apparatus, comprising:
generating a first image which has a first dynamic range, and to which first noise reduction processing has been applied, from a shot image;
generating a second image which has a second dynamic range, and to which the first noise reduction processing has been applied, from the shot image;
generating a third image which has the second dynamic range, and to which second noise reduction processing has been applied at an intensity independent of the first noise reduction processing, from the shot image;
generating, based on the first image and the second image, a gain map for converting a dynamic range of the third image into the first dynamic range; and
associating the gain map with the third image.

14. A non-transitory computer-readable storage medium which stores a program for causing a computer to execute a method comprising:
generating a first image with a first dynamic range from a shot image;
generating a second image with a second dynamic range from the shot image;
generating, based on the first image and the second image, a gain map for converting a dynamic range of the second image into the first dynamic range;
applying first noise reduction processing to the gain map; and
associating the gain map with the second image.

15. A non-transitory computer-readable storage medium which stores a program for causing a computer to execute a method comprising:
generating a first image which has a first dynamic range, and to which first noise reduction processing has been applied, from a shot image;
generating a second image which has a second dynamic range, and to which the first noise reduction processing has been applied, from the shot image;
generating a third image which has the second dynamic range, and to which second noise reduction processing has been applied at an intensity independent of the first noise reduction processing, from the shot image;
generating, based on the first image and the second image, a gain map for converting a dynamic range of the third image into the first dynamic range; and
associating the gain map with the third image.
